(19) United States
(12) Patent Application Publication
(10) Pub. No.: US 2004/0203751 A1
(43) Pub. Date: Oct. 14, 2004

(54) Peer-to-peer (P2P) collaborative system for service aggregation, rapid service provisioning and service roaming

(75) Inventor: Maryam Banaei, Ottawa (CA)

Correspondence Address: GREER, BURNS & CRAIN, 300 S WACKER DR, 25TH FLOOR, CHICAGO, IL, 60606, US

(73) Assignee: Excino Technologies Inc.

(21) Appl. No.: 10/274,740

(22) Filed: Oct. 21, 2002

(51) Int. Cl. H04Q 7/20; H04M 11/00; H04M 3/16

(52) U.S. Cl. 455/432.1; 455/411; 455/408; 370/338

(57) ABSTRACT

A system and method for dynamically providing short term services to end users in a wireless network by establishing a trusted peering working group between numerous service providers (such as WLAN access providers) wherein the end user is extended access to local services by the visited WISP (wireless internet service provider) while maintaining a formal customer-vendor relationship with a single home service provider.

### FIELD OF INVENTION

This invention generally relates to an intersection between the fields of communication and computing. More particularly, it applies methods from computing domain to create a collaborative system for service provisioning and deployment to roaming users. It has an immediate and obvious benefit to 802.11 Wireless Local Area Network (WLAN) service providers and roaming users, offering WLAN access outside the scope of the home provider. Furthermore, it enables new transactional-oriented services to service providers and users who are currently bound to subscription-oriented services.

### BACKGROUND OF INVENTION

Peer-to-Peer (P2P) Methods & concepts known to the computing world Gartner Group describes P2P computing as: “a set of computing nodes that treat each other as equals (peers) and supply processing power, content or applications to other nodes in a distributed manner, with no presumptions about a hierarchy of control”. Gunjan Samtani & Dimple Sadwani define a Peer Group as: “a collection of peers that agree to a common set of rules to generate, publish and exchange information. It is up to the group members to decide the governance rules like membership policy from public (open to all) to private (highly secured—open only by invitation) group”.

Opportunity for Wireless Local Access Network (WLAN) Roaming

Internet-Draft document “Draft-caron-public-wlan-roaming-issues-00.txt” describes the requirement for public WLAN roaming as follows: “it is necessary to build up critical mass, by having very extensive coverage, without the need for users to sign up with multiple different providers. A WLAN cell coverage radius is only a few hundred meters. For this reason, WLAN coverage by any operator remains limited, and a much larger number of operators of all sizes (from one access point to several thousands or more) will be required to get any decent coverage and reach critical mass.” Caron breaks-down this domain requirement to functional requirements such as : transparency that does not require manual action from users, security, scalability, cost transport and accounting as well as other implicit requirements such as audit to ensure “visited networks” cannot cheat on accounting by extending session durations beyond their real lifetime.

Currently, most of these functional requirements focus on user authentication and there exists two main approaches:

1) WECA WISP & WISPr for Committee Approach

(WECA=Wireless Ethernet Compatibility Alliance) & (WISPr=Wireless ISP roaming)

2) Smart Client (ipass client or Gric client) for Aggregator Approach

The invention suggests that there is a 3^{rd} approach that is far more appropriate to the collaborative nature of the domain. Furthermore, both short cell coverage of the current WLAN implementation and standard user authentication experience are simply the initial implementation barriers associated with this relatively new and immature technology. This invention recognizes that WLAN access is not the only desired service to the end user. The invention defines the real requirement as a system that enables collaborative services and facilitates peering agreements beyond simple network access, for extended services. P2P methods, known to the computing domain, are the ideal technology for implementing peering groups that can agree on membership policy, and fundamentals of a trusted relationship. Historically, a Committee driven approach is a slow process and the Aggregator approach eventually ends-up requiring some kind of peering agreement among the aggregators. Thus, this invention effectively complements and technically enables both Committee and the Aggregator Approaches.

Opportunity beyond Wireless Local Area Network (WLAN) Access:

The invention enables an extended definition of “roaming” for end-users. An end-user who gets authenticated on a visiting network may request three types of services:

1) Simple Network Access

2) Local service only available by the Local Provider, such as an airline service available by the airport WISP (Wireless Internet Service Provider that provides WLAN Access)

3) An End-to-end service that involves another collaborating Service Provider such as the Home Service Provider.

Available services can be transactional-oriented such as playing a local game or meter-oriented such as duration of network access. The invention enables access to local Agent-based Services or Web Services as well as a secure exchange of accounting information, required for “roaming services” among collaborative peers.

The recent competition and overlap between telecommunication and internet communication services, has introduced a trend for co-existing overlaid networks. The traditional world of telecommunication has been designing methods for generic network access services, attempting to enable “user roaming” for very limited services, often embedded in the core network infrastructure. The invention is different; it does not suggest methods for extending an existing closed system. It applies proven methods from P2P computing and P2P applications, to create a platform for collaborative service creation, provisioning, and deployment.

A further example, as illustrated in FIG. 1, describes what is known as the billing gate-keeper model, as exercised by monopolies such as NTT DoCoMo, which is a closed system whereby the service providers centralize their services which are then redistributed by said monopolies. This results in little flexibility for the smaller partners involved with the monopolies and accordingly limits their chances of expanding their revenues.

Therefore, there is a need for a system that facilitates creation of services at the edge of a network and provides secure exchange of information between collaborating service providers resulting in a convenient way of providing services to the end user in a visited area and for convenient managing of accounting and billing matters.

### SUMMARY OF THE INVENTION

It is an object of the present invention to enable collaboration among a diverse set of Service Providers who collectively offer a wider range of services to the end-users. By applying the P2P methods, initially designed for end-device and end-user applications, to the service creation at the edge of a network, this invention enables a collaborative and distributed platform for service creation and deployment. This invention customizes P2P methods to create a dynamic peer-group of Service Providers, each advertising its special services while mutually or collectively agreeing on collaborating with regards to a specific or a group of services.

It is a further object of the present invention to provide extended management features for the peer-group. The management features consist of mechanisms for defining and implementing group policy. For example, this invention enables definition and implementation of “trust” among peers, based on exchange of certain type of security-certificates or compliance with certain certificate authority. Peering policy may also require definition and implementation of a secure message-exchanging protocol among the peers. This invention enables the use of encryption algorithms, for the message exchanges among the peering service providers.

Additional management features enable peer collaboration for specific type of services. For example, collaboration among WLAN providers, known as WISPs. This invention extends the capability of each peer with an agent adaptation feature. Thus, WISPs, agreeing on a certain kind of user authentication mechanism, can collaborate easily and enable user roaming. The system also enables a safe exchange of accounting information as well as an audit-agent that completes the business requirements for Wireless LAN Roaming.

Furthermore, the distributed P2P nature of this system intrinsically satisfies the scalability requirement for Wireless LAN Roaming.

This invention completes the peer-collaboration between any Service Provider that owns the customer information and any Application/Service Provider that could offer additional services to end-users on short-time and transactional basis.

By providing a flexible delivery platform for agent-based services, the present invention not only enables service-level roaming, such as personalized content or location-based services, but also the deployment of short-lived, on-demand services that will contribute significant incremental revenues for the service providers.

The present invention solves the problems of the prior art by providing a method and system that facilitate the exchange of information, and in particular, information between WISPs. Once the information is obtained by the visited WISP from the home service provider, services can be provided seamlessly to the end user with no need for said user to have to deal with anyone but his home service provider for accounting and billing.

Advantageously, the present invention overcomes the limitations associated with collaborative heterogeneous systems by adapting an existing communications network to exchange information between agents with respect to a specific service.

It is an object of the present invention to enhance the ability of the end-users to access WLANs in a simple, cost efficient manner.

It is a further object of the present invention to provide value-added services to collaborating service providers by offering inter-peer specialized management solutions.

It is yet a further object of the present invention to provide a method and system providing for the delivery of additional services generating new revenue streams, attracting new users and strengthening the competitive position of ISPs.

Thus, in a preferred embodiment of the invention, there is provided a method for providing a trusted working group between collaborative peers, applied to service providers offering end users with roaming, comprising the steps of: establishing a trusted peering working group between home and visited service providers; investigating user-authorization by the visiting service provider; establishing user-authentication by the visiting provider; confirming user-authorization by the home service provider; connecting the end-user to the services of the visited service provider as requested by said end user; maintaining appropriate transaction and accounting records; and, billing by the home provider; wherein the end user is extended access to local services by the visited service provider pursuant to established peering agreements between said home service provider and said visited service provider while maintaining a formal customer-vendor relationship with a single service provider.

In another preferred embodiment of the invention, there is provided a system for providing WLAN to end-users, comprising: means for managing a peering working group between service providers; means for initiating user-authentication and authorization; means for maintaining transaction and accounting records; and means for billing an end-user.

In a further preferred embodiment of the invention, there is provided a method for providing on demand location-based services to end users in a wireless network comprising the steps of: establishing a trusted peering working group between home and visited service providers; accessing stored user profile data corresponding to the identified user to determine the access of services available to said user; connecting said user to the service selected, wherein said user has access to a visited wireless service provider's services; exchanging data with respect to the service provided by the visited wireless service provider; connecting the end-user to the services of the visited service provider as requested by said end user; maintaining appropriate transaction and accounting records; and billing by the home provider; wherein the end user is extended access to local services by the visited wireless service provider pursuant to established peering agreement between said home service provider and said visited service provider while maintaining a formal customer-vendor relationship with a single service provider.

### BRIEF DESCRIPTION OF THE DRAWINGS

FIG. 1 is a schematic depicting a known business model, proven for monopoly closed systems and remaining valid for this invention;

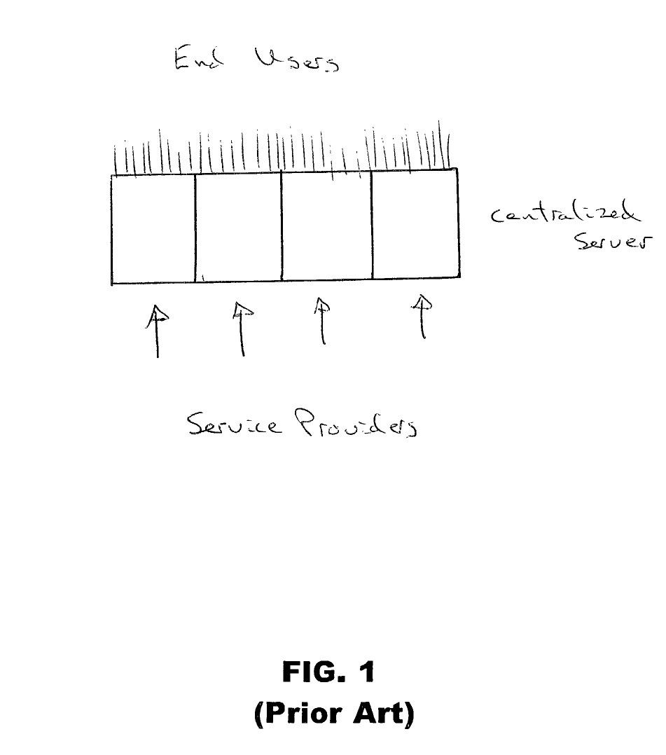

FIG. 2 is a schematic depicting an exemplary embodiment of the present invention according to a preferred embodiment;

FIG. 3 is a schematic depicting the value chain of the exemplary embodiment of the present invention; and

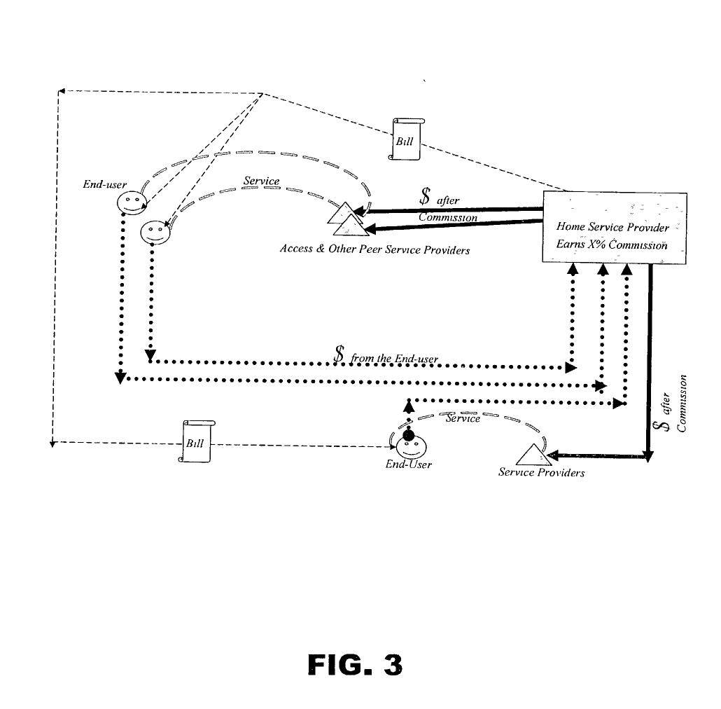

FIG. 4 is a schematic depicting an embodiment of the peer-to-peer service delivery platform of the method and system of the present invention.

### DETAILED DESCRIPTION OF THE PREFERRED EMBODIMENTS

The term peer-to-peer (P2P) refers to a class of systems and applications that employ distributed resources to perform a critical fit in a decentralized manner. An agent is defined as a software entity responsible for an automated process, responding to a data query or systematically executing a set of predefined heuristics. The present invention applies a P2P architecture as a platform for collaborating agents and the delivery of dynamic services. This invention enables “service roaming”, as well as a collaborative business model for service providers seeking to partner with distributed peers who deliver wireless LAN access and/or application services.

The concept of roaming was initially defined in mobile telephony and recently has been redefined in wireless networking. While the multiple definitions, from telephony and networking domains, are still converging an extended definition for “service roaming” is appropriate.

RFC 2477: “Roaming capability” is defined as the ability to use multiple Internet service providers (ISPs) while maintaining a formal, customer-vendor relationship with only one. Roaming requires End-user authentication in compliance with a business relationship with roaming partners.

In wireless networking, roaming refers to the ability to move, from one access point coverage to another, without interruption in service or loss in connectivity.

Herein, “service roaming” is defined as the ability for an end-user to maintain a formal customer-vendor relationship with a single service provider, combined with access to extended local services dynamically. While moving from one wireless access provider's coverage zone to another, end-user is authenticated and authorized in compliance with an established peering agreement between her home service provider and the visited service provider and gets extended access to local services.

The home service provider is defined as the business entity that holds a business agreement with the end-user/customer. The visited service provider is defined as the business entity that offers a local service (network access or application access) to an end-user where there is no business agreement with that end-user. The home service provider also holds “peering agreements” with potentially many other wireless access or application providers. The home service provider performs the authorization function for its customers and the billing function, for any peer services that are offered to its customers.

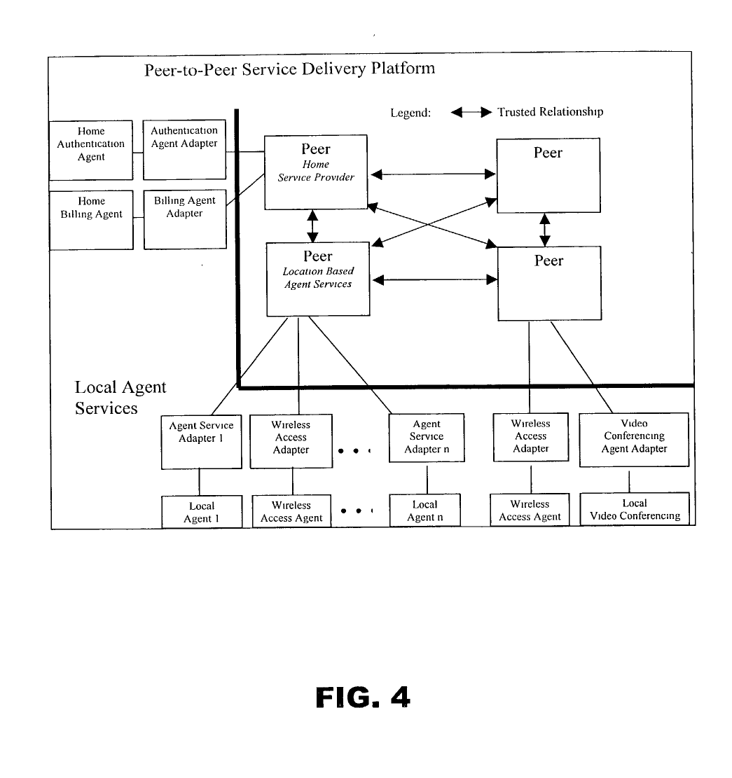

Referring to FIG. 4, the method and system of the present invention enables a group of service providers to establish a peering working group, each advertising sets of local services available to end-users, eg. without being restrictive, internet access, location-based services and other IP-based services. These peers agree to provide local services to end-users while relying on pre-established user-authorization and billing mechanisms, to be performed by the home service provider. The “service roaming” of the present invention enables the provision of multiple services by collaborating peers in an open system, where service creation and provisioning is not controlled and managed by a single monopoly.

Specifically, there is provided a method for dynamically making available and providing short term services to end users geographically removed from the area of their home wireless LAN provider whereby a trusted peering working group of service providers has been established pursuant to agreements entered into by said service providers. User-authentication is established by the visiting service provider and user-authorization is confirmed by the home service provider, once a request for service has been received from a visiting WLAN access/service provider, to the home service provider database who maintains the user profile. In this fashion, it can be seen that a user need not establish multiple user accounts in a multitude of jurisdictions. The user is then connected by the visited service provider to the service requested, all in a seamless fashion. Appropriate transaction and accounting records are maintained pursuant to the method of the present invention and billing is done by the home service provider, with a certain percentage being added for handling the transaction. Payment is then made to the visited service provider by the home service provider, all of this leaving the end-user without having to deal with any other service providers but her own home service provider. The end-user is extended access to local services by the visited service provider pursuant to established peering agreement between the service providers while maintaining a formal customer-vendor relationship with a single service provider.

Data indicative of at least the identity of the user, the network access service used and the duration of such usage is maintained by the providers of the services which data can be transmitted back to the home service provider if and when requested.

Pursuant to a preferred embodiment of the present invention, there is provided a system for providing seamless wireless LAN access to an end-user which is comprised of processor means for managing a peering working group between numerous service providers, means for initiating user-authentication and confirming user-authorization in order to ensure the security of transactions and to avoid fraudulent usage, means for maintaining transaction and accounting records and means for billing an end-user pursuant to said peering working agreements.

It can be seen from the above that a method and system for providing on demand instantaneous location-based services to end users is provided and is only dependent on the number of service providers being part of the peering working group. The larger the peering working group, the more services available and the more territory being covered by the home service provider.

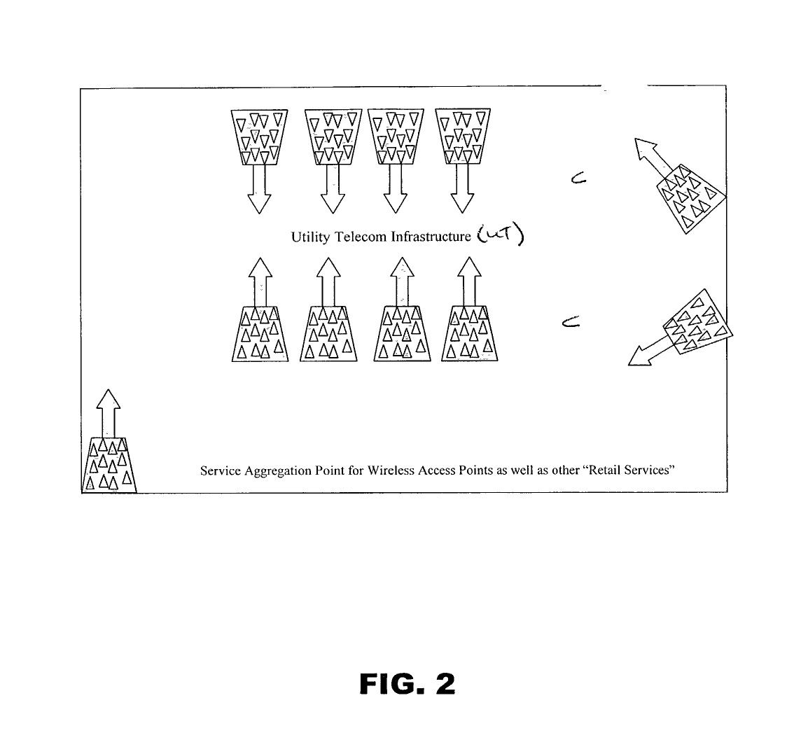

Referring to FIG. 2, an example for “service roaming” for corporate customers, pursuant to a preferred embodiment of the invention is provided:

Corporation C is a customer of Utility Telecomm UT, operating in a defined geographical area. Corporation C requires an 802.1x authentication mechanism for its 802.11 wireless LAN access and requires roaming for its employees. Utility Telecomm UT establishes peering agreements with many 802.11 Wireless Access Providers who are willing to provide on-demand wireless access to visitors. The 802.11 Wireless Access Providers get paid by the Utility Telecomm UT for services consumed and accounted for; UT adds X% commission for billing and customer handling and directly bills Corporation C. In this example, Wireless Access via 802.11 is only a basic commodity service. But, a roaming corporate user may need another temporary service such as video broadcasting from 8-10 am in the morning, from a local video conferencing provider. As long as the local provider has a service peering agreement with Utility Telecomm UT, the corporate user has access to on demand (transaction-oriented) services. Furthermore, the local provider has extended its customer base, to include visiting corporate customers. Thus, the Utility Telecomm UT gains extended revenue generating options, from these dynamic, short-term, transaction-oriented services.

In this case, the home service provider (UT) offers customer billing and may not directly offer other services to end-users itself. UT having the detailed customer profile may seamlessly provide services to its customer base through its peering partners which may offer a mixed set of services. This is a centralized billing model which may be enabled with further peering working groups formed down the line from UT according to the method of the present invention.

As illustrated in FIG. 4, the implementation of the present invention uses a P2P platform as the means for creating trusted peering groups, advertising, publishing services as well as piping messages. Each peer is extended with plug-in adapters, for initiating local services. User profiles are maintained and protected by the home service provider.

The most obvious and familiar case of “service roaming” occurs when a user requests access from a local authenticator agent that is different from the user's home agent. In the implementation of the present invention, the local authenticator agent consults the home agent, receives authorization and forwards all accounting information to the home agent for direct customer billing. However, the concept of “service roaming” includes extended local services that may not even exist or be offered by the home service provider.

The “service roaming” architecture also provides the means for an audit-agent for customer complaint resolution. Necessary transaction and accounting information can be independently maintained; where the service was actually initiated, to ensure the home service provider can verify and validate the end-user's usage or consumption of billable services.

To an end-user, the benefits of “service roaming” are an ability to dynamically subscribe to short-term, timely required, location-based services while dealing with a single home service provider for subscription billing. To a home service provider, the benefits are additional revenue generated by peering partner services, enabled by the ability to engage in dynamic business agreements for local and/or time sensitive on-demand services. To a local access or application provider (peer), the benefits are: ability to offer new, on demand, location specific, culturally suitable services and gain incremental revenues from visiting non-subscriber end-users.

The invention is not limited to the embodiments herein before described, but may be varied within the scope of the claims in construction and detail.

We claim:

1. A method for providing a trusted working group between collaborating peers, applied to service providers offering end users with roaming comprising the steps of:
a) establishing a trusted peering working group between home and visited service providers;
b) investigating user-authorization by the visiting service provider;
c) establishing user-authentication by the visiting service provider;
d) confirming user-authorization by the home service provider;
e) connecting the end-user to the services of the visited service provider as requested by said end user;
f) maintaining appropriate transaction and accounting records; and
g) billing by the home provider;
wherein the end user is extended access to local services by the visited service provider pursuant to established peering agreements between said home service provider and said visited service provider while maintaining a formal customer-vendor relationship with a single service provider.

2. A method according to claim 1, wherein user profile data is held in a database forming part of the home provider system.

3. A method according to claim 2, wherein said database is accessible by the visited service provider.

4. A method according to claim 1, wherein a user-authentication and authorization exchange is effected over a virtual P2P network between the home service provider and visited service provider.

5. A method according to claim 1, further involving generating for each successful service provided, data indicative at least of the identity of the user, the network access service used and the duration of such usage.

6. A method according to claim 5, further involving providing the data to the home service provider.

7. A method according to claim 6, further involving generating a billing record by the home service provider according to established peering working group agreements.

8. A method according to claim 7, further involving generating a payment from the home service provider to the visited service provider according to established peering working group agreements.

9. A method according to claim 1, wherein the service providers are WLAN access providers.

10. A system for providing WLAN access to end-users, comprising:
a) means for managing a peering working group between service providers;
b) means for initiating user-authentication and authorization;
c) means for maintaining transaction and accounting records; and
d) means for billing an end-user.

11. A method for providing on demand location-based services to end users comprising the steps of:
a) establishing a trusted peering working group between home and visited service providers;
b) accessing stored user profile data corresponding to the identified user to determine the access of services available to said user;
c) connecting said user to the service selected, wherein said user has access to a visited wireless service provider's services;
d) exchanging data with respect to the service provided by the visited wireless service provider;
e) connecting the end-user to the services of the visited service provider as requested by said end user;
f) maintaining appropriate transaction and accounting records; and,
g) billing by the home provider;
wherein the end user is extended access to local services by the visited wireless service provider pursuant to established peering agreement between said home service provider and said visited service provider while maintaining a formal customer-vendor relationship with a single service provider.

12. The method according to claim 11, wherein the user can select a plurality of services.

13. The method according to claim 11, wherein the user can have access to the wireless network access services provided by a plurality of wireless network service providers without having to separately subscribe to those providers.
